(19) United States
(12) Patent Application Publication
(10) Pub. No.: US 2007/0067498 A1
(43) Pub. Date: Mar. 22, 2007

(54) System and method for information handling system video input and output

(76) Inventors: Kurt J. Lippert, Austin, TX (US); Randall E. Juenger, Belton, TX (US); Sean P. O'Neal, Austin, TX (US)

Correspondence Address: HAMILTON & TERRILE, LLP, P.O. BOX 203518, AUSTIN, TX, 78720, US

(21) Appl. No.: 11/202,518

(22) Filed: Aug. 12, 2005

(51) Int. Cl. G06F 3/00

(52) U.S. Cl. 710/1

(57) ABSTRACT

Visual information is selectively input or output from an information handling system video connector to support presentation of external visual information input to the connector at a display of the information handling system or presentation of internal visual information output from the connector at an external display. A multiplexer selectively interfaces the connector with a graphics controller to output analog visual information or with a video decoder to receive analog visual information for conversion to a digital format and communication to the graphics controller. In one embodiment, input of an external signal to the connector automatically configures the information handling system to receive and display the external visual information.

### BACKGROUND OF THE INVENTION

1. Field of the Invention

The present invention relates in general to the field of information handling system displays, and more particularly to a system and method for information handling system video input and output.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems have a variety of interfaces to input and output information. For example, typical information handling systems include one or more video output interfaces that output video information from the system for presentation at a display, such as VGA and DVI outputs or more specialized S-Video, composite or component video outputs that output television compatible signals. The use of such standardized interfaces allows a wide variety of types of information handling system devices to present information at either displays or televisions, such as gaming devices like XBOX and PSII or set top television displays. Indeed, the introduction and use of high definition televisions has brought about a convergence of information handling system and television technology for improved resolution of images in the presentation of visual information received from either an information handling system or a television signal. As an example, an information handling system with a S-Video connector communicates visual information through an internal graphics card to output a television compatible signal through the S-Video connector for display of the visual information at a television.

Although information handling systems are typically configured to interface with external display devices, typical portable information handling systems have a display integrated in their housing. Generally, portable information handling system displays use liquid crystal display (LCD) panels because LCD panels have a thin configuration that fits in a housing lid and also because LCD panels present a high quality display with relatively little power consumption. These same characteristics have made LCD panels a popular option among consumers for use both as information handling system peripheral displays and as televisions. However, LCD panels that are integrated into portable information handling systems are typically not available to accept and display visual information from external information handling systems or devices. Instead, visual information from external devices is first typically processed by the portable information handling system before communication to the integrated display panel through the internal graphics card. For instance, external TV tuner modules provide television visual information through a USB interface which is transferred from the USB interface through an internal bus, such as MMI or PCI Express bus, is encoded and compressed to MPEGII by internal components and output to the LCD panel through an LVDS output. Internal encoding and compressing of the visual information introduces delays, desynchronizes video and audio information and reduces image quality. Further, such external devices are expensive and complex to use.

### SUMMARY OF THE INVENTION

Therefore a need has arisen for a system and method which accepts visual information for presentation at a display integrated in an information handling system.

In accordance with the present invention, a system and method are provided which substantially reduce the disadvantages and problems associated with previous methods and systems for presenting external visual information at a display integrated in an information handling system. External visual information is input to an information handling system integrated display by selectively configuring a connector for outputting internal visual information to an external display to instead receive inputs of external visual information. The external visual information is converted to a format used by the integrated display and communicated to the integrated display for presentation of the external visual information.

More specifically, a graphics controller disposed in an information handling system housing accepts information generated by processing components disposed in the housing and provides the internally generated information to an integrated display panel for presentation in a display format, such as through a LVDS bus. The graphics controller also converts the internal visual information from a digital form to an analog form for presentation at an external display through connector, such as a S-Video or composite video connector. The connector selectively configures to accept signals from the graphics controller for output to an external display, such as a television, or to accept signals input from an external device, such as a set top box or gaming device, and provide the input external signals to the graphics controller. A multiplexer interfaces the graphics controller with the connector to output the internal visual information and switches the connector to instead interface with a video decoder to input external visual information. The video decoder converts the external analog signal to digital information and communicates the converted external visual information to a video port of the graphics controller, such as in 656 video format. In one embodiment, a connector selector automatically interfaces the connector with the video decoder when an external signal is detected at the connector and automatically interfaces the connector to the graphics controller when no external signal is detected at the connector.

The present invention provides a number of important technical advantages. One example of an important technical advantage is that visual information from an external source is presented at a display integrated in an information handling system. The use of a common connector to both input and output visual information reduces costs by sharing input and output functions with one set of hardware. Further, the use of the same connector simplifies user interaction with the connector by automated selection at the interface of input or output functions based on the signals present at the connector. Information handling system users are thus able to present high quality images with LCD panels of portable information handling systems that are communicated from external devices. Improved quality presentation of external visual information is achieved by providing raw uncoded video from the analog source through an analog-to-digital converter of the video decoder and directly to the graphics frame buffer.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts block diagram of an information handling system having a video connector configurable to input or output visual information; and

FIG. 2 depicts a flow diagram of a process for selectively inputting or outputting visual information from an information handling system video connector.

### DETAILED DESCRIPTION

An information handling system video connector selectively inputs or outputs visual information to support display of external visual information at an integrated display panel of the information handling system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

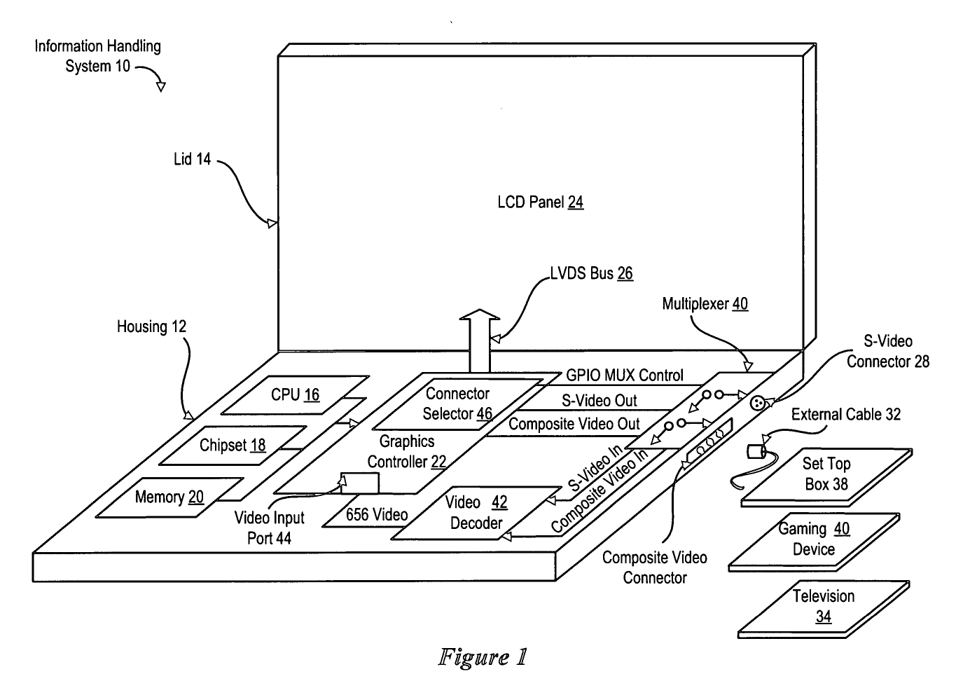

Referring now to FIG. 1, a block diagram depicts an information handling system 10 having a video connector configurable to input or output visual information. Information handling system 10 is configured as a portable system having a housing 12 and a hinged lid 14. Housing 12 has plural processing components disposed in it, such as a CPU 16, chipset 18, memory 20 and graphics controller 22, which support applications to generate visual information for presentation to a user. Hinged lid 14 integrates a liquid crystal display panel 24 that receives the visual information through a LVDS bus 26 and presents images formed from the visual information. Visual information generated internally on the processing components is generated as digital information and formatted as digital LVDS information by graphics controller 22 for use by pixels of LCD panel 24. Graphics controller 22 also formats the internal visual information as analog visual information for communication to external devices, such as television compatible signals that are communicated to a television connector. For instance, graphics controller 22 converts internal digital visual information into a S-Video signal for communication to a S-Video connector 28 or a composite video signal for communication to a composite video connector 30. An external cable 32 interfaced with connector 28 or 30 communicates the analog television signal for presentation at an external device, such as a television 34.

External connectors 28 and 30 are selectively configurable to receive inputs of external visual information for presentation at display 24 instead of outputting internal video information from graphics controller 22. For instance, analog television signals generated by external devices, such as a gaming device 36 or set top television device 38, are communicated through external cable 32 to S-Video connector 28 or composite video connector 30 and converted to digital visual information for presentation at LCD panel 24. A multiplexer 40 selectively interfaces connectors 28 and 30 with output from graphics controller 22 to output internally generated visual information or selectively interfaces connectors 28 and 30 with a video decoder 42 to input externally generated visual information. Video decoder 42 converts the analog visual information received in S-Video or composite video formats into 656 video digital visual information for input to a video port 44 of graphics controller 22. For instance, video decoder 42 is a Conexant 25836 unit that transmits converted 656 data as uncompressed YUV data that is sent to frame buffer memory of graphics controller 22 through port 44. Graphics controller 22 scans the pixel data from the frame buffer memory to LVDS bus 26 for presentation at display 24.

The selective configuration of external connectors 28 and 30 to either input or output visual information is manually set by a user interface, such as through the BIOS, or automatically determined by a connector selector 46. Multiplexer 40 defaults to an output mode in which internally generated visual information is output from connectors 28 and 30 and analog television compatible signals. Connector selector 46 monitors connectors 28 and 30 for external signals and uses a GPIO multiplexer control signal to switch connectors 28 and 30 from a direct connection to graphics controller 22 to an indirect connection through video decoder 42. Once connector selector 46 detects the absence of external signals, another GPIO multiplexer control signal switches connectors 28 and 30 to again have a direct connection with graphics controller 22. Periodic monitoring of the connectors for external signals provides a prompt response to present external information at LCD panel 24 in a manner that is automatic for a user of the system.

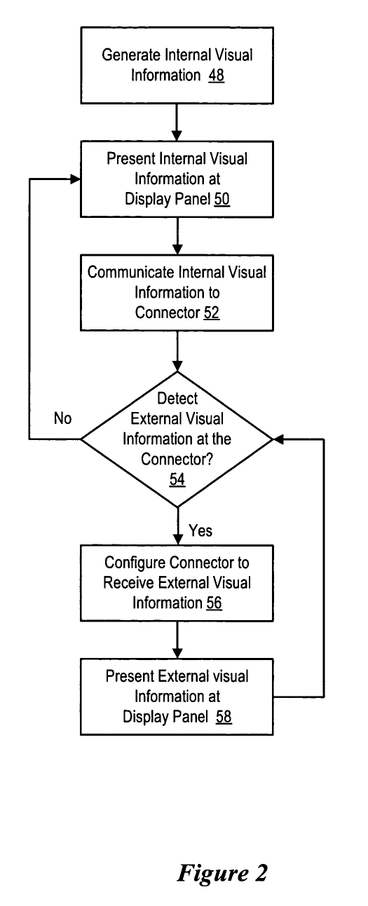

Referring now to FIG. 2, a flow diagram depicts a process for selectively inputting or outputting visual information from an information handling system video connector. The process begins at step 48 with the generation of internal visual information by processing components disposed in the housing of the information handling system. At step 50, the internal information is presented at a display panel integrated in the information handling system, such as with an internal graphics controller. At step 52, the internal visual information is converted to analog television compatible formats and communicated to connectors, such as S-Video, composite video or component video connectors, to make the internal visual information available for display at an external television device. At step 54, a determination is made of whether external visual information is input at the connectors, such as an externally generated analog television compatible signal. If no external signals are detected, the process returns to step 50 to continue the display of internal visual information at the integrated display. If an external visual information signal is detected at step 54, the process continues to step 56 to configure the connector to receive external visual information. At step 58, the external visual information is presented at the integrated display by decoding the analog signal and generating digital visual information for use by the graphics controller. Periodically, the process returns to step 54 to confirm that external visual information continues at the connector.

Although the present invention has been described in detail, it should be understood that various changes, substitutions and alterations can be made hereto without departing from the spirit and scope of the invention as defined by the appended claims.

What is claimed is:

1. An information handling system comprising:
a housing;
plural processing components disposed in the housing and operable to generate digital visual information;
a display integrated in the housing and operable to present the visual information;
a graphics controller disposed in the housing and interfacing the plural processing components with the display, the graphics controller operable to accept the digital visual information and convert the digital visual information into a display format for communication to the display, the graphics controller further operable to convert the digital visual information into analog visual information;
a video decoder disposed in the housing, the video decoder operable to accept analog visual information and to convert the analog visual information to digital visual information for communication to the graphics controller;
a video connector disposed in the housing and operable to communicate analog visual information; and
a multiplexer disposed in the housing and operable to selectively interface the connector with the graphics controller to output analog visual information from the graphics controller through the connector or with the video decoder to input analog visual information from the connector for communication to the graphics controller through the video decoder for presentation at the display.

2. The information handling system of claim 1 wherein the video connector comprises a S-Video connector.

3. The information handling system of claim 1 wherein the video connector comprises a composite video connector.

4. The information handling system of claim 1 further comprising a video connector selector interfaced with the multiplexer and operable to automatically selectively interface the video connector with the video decoder if a video signal is input at the video connector from an external device.

5. The information handling system of claim 1 wherein the video converter converts the analog visual information into 656 formatted information for communication to the graphics controller as uncompressed YUV information.

6. The information handling system of claim 1 wherein the display comprises a LCD panel.

7. The information handling system of claim 6 wherein the display format comprises LVDS.

8. The information handling system of claim 1 wherein the analog visual information at the video connector comprises a television signal from a set top box.

9. The information handling system of claim 1 wherein the analog visual information at the video connector comprises a television signal from a gaming system.

10. A method for displaying visual information at an information handling system, the method comprising:
generating internal visual information with processing components disposed in the information handling system;
presenting the internal visual information at a display integrated in the information handling system;
communicating the internal visual information to a video connector disposed in the information handling system;
connecting a cable to the video connector, the cable having external visual information generated by a device external to the information handling system;
configuring the video connector to receive the external visual information from the external device instead of the internal visual information; and
presenting the external visual information at the display.

11. The method of claim 10 further comprising:
disconnecting the cable from the video detector; and
reconfiguring the video connector to receive the internal visual information.

12. The method of claim 11 wherein the video connector comprises a S-Video connector.

13. The method of claim 11 wherein the video connector comprises a composite video connector.

14. The method of claim 11 wherein the display comprises a LCD panel.

15. The method of claim 10 wherein configuring the video connector further comprises:
selectively interfacing the video connector to communicate with a graphics controller through a video decoder instead of communicating directly with the graphics controller.

16. The method of claim 15 wherein selectively interfacing further comprises:
activating a multiplexer to connect the video connector with a video decoder.

17. A system for presenting visual information at an information handling system display, the system comprising:
a graphics controller operable to receive visual information and to output the visual information in a first format for presentation at a display and in a second format for communication from a connector;
a video decoder operable to receive visual information from the connector in the second format, convert the visual information and communicate the converted information to the graphics controller for output in the first format and presentation at the display; and
a multiplexer selectively interfacing the connector with the graphics controller to output the visual information from the connector in the second format or with the video decoder to input the visual information from the connector in the second format.

18. The system of claim 17 further comprising a connector selector interfaced with the multiplexer and operable to automatically interface the connector with the video decoder if an external signal is detected at the connector.

19. The system of claim 17 wherein the connector comprises a S-Video connector.

20. The system of claim 17 wherein the connector comprises a composite video connector.
